(19) United States
(12) Patent Application Publication
(10) Pub. No.: US 2024/0364547 A1
(43) Pub. Date: Oct. 31, 2024

(54) TRAFFIC STEERING POLICY AND SELECTION OF SERVICE FUNCTION CHAIN IN V-PLMN WITH LOCAL BREAKOUT

(71) Applicant: Cisco Technology, Inc., San Jose, CA (US)

(72) Inventors: Sanjeev Panem Jaya, Pune (IN); Ravi Shekhar, Pune (IN)

(21) Appl. No.: 18/307,175

(22) Filed: Apr. 26, 2023

(51) Int. Cl. H04L 12/14; H04W 28/08

(52) U.S. Cl. CPC H04L 12/1407; H04W 28/0846

(57) ABSTRACT

A mechanism is provided for traffic classification based on service function chain (SPC) rules in a visiting public land mobile network (V-PLMN) in case of local breakout roaming scenarios. The SPC rules provisioned in the H-PLMN are provided to functions in the V-PLMN which would use the local configuration and traffic conditions to map the rules to a service function path (SFP).

### TECHNICAL FIELD

The present disclosure relates to mobile networking.

### BACKGROUND

In the current Third Generation Partner Project (3GPP) mobile network architecture, a Session Management Function (SMF) in a home public land mobile network (H-PLMN) is provisioned by a home network Policy Control Function (H-PCF) with a traffic steering policy that is used to enable traffic steering to a N6-local area network (LAN), Data Network (DN) and/or Data Network Access Identifiers (DNAIs) associated with N6 traffic routing. A User Plane Function (UPF) with service function chaining (SFC) capability is selected and configured by the SMF to choose the proper service function chain through N4 rules. The SFC policy works in the home network but needs to be extended to the visiting PLMN (V-PLMN) for local breakout roaming scenarios.

### BRIEF DESCRIPTION OF THE DRAWINGS

FIG. 1 is a block diagram illustrating an environment in which a mapping is made for service function chaining between a home network and a visiting network for local breakout processing of traffic for a user device, according to an example embodiment.

FIG. 2 depicts a diagram that illustrates the overall concept of service function chaining that may be used for the mapping of a service function chain in a visiting network as shown in FIG. 1.

FIG. 3 is a high-level flow chart depicting a method according to an example embodiment.

FIG. 4 illustrates a sequence diagram depicting message flows among the network elements, according to an example embodiment.

FIG. 5 illustrates a hardware block diagram of a computing device that may perform functions associated with operations discussed herein, in accordance with an example embodiment.

### DESCRIPTION OF EXAMPLE EMBODIMENTS

### Overview

Presented herein are techniques to address the case of roaming with local breakout, where the home network provides the traffic steering policies and service function chaining policies to the visiting network that provides local breakout. This enables support of service function chaining in the visiting network.

In one form, a method is provided comprising: configuring one or more service function chaining policies in a visiting network for local breakout roaming traffic associated with a user device that has roamed to the visiting network from a home network, by mapping one or more service function chaining policies of the home network to the one or more service function chaining policies of the visiting network; and directing the local breakout roaming traffic for the user device in the visiting network to a service function chain determined based on the mapping.

### EXAMPLE EMBODIMENTS

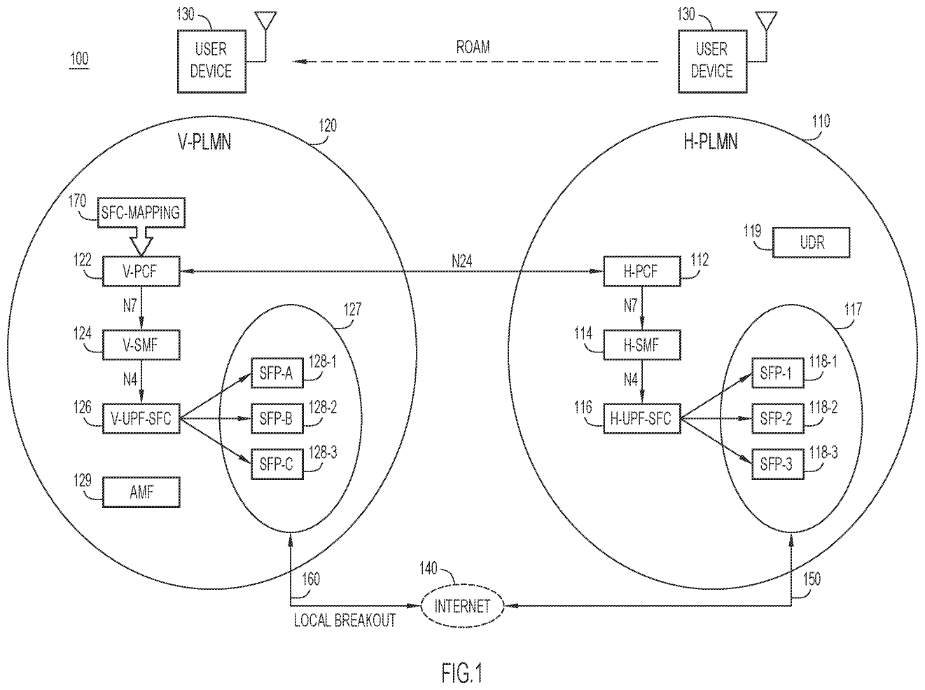

Reference is made to FIG. 1, which shows a mobile network environment 100 that includes a home public land mobile network (H-PLMN 110) and a visiting public land mobile network (V-PLMN) 120. A user equipment or user device 130 is configured to operate in H-PLMN 110 as its home network but has subscribed to be provided with wireless communication services in the V-PLMN 120 when it has roamed away from coverage of the H-PLMN 110 into coverage of the V-PLMN 120.

The H-PLMN 110 includes a home Policy Control Function (H-PCF) 112, home Session Management Function (H-SMF) 114 and home User Plane Function-Service Function Chain (H-UPF-SFC) 116. The H-PCF 112 communicates with the H-SMF 114 via a N7 interface, for example, and the H-SMF communicates with the H-UPF-SFC 116 via an N4 interface, as an example. H-UPF-SFC 116 directs user plane traffic associated with the user device 130, over an N6-LAN 117, to an SFC based on one of a plurality of Service Function Paths (SFPs). As an example, there are three SFPs configured in H-PLMN: SFP-1, SFP-2 and SFP-3, shown at reference numerals 118-1, 118-2 and 118-3, respectively. The H-PLMN 110 further includes a Unified Data Repository (UDR) 119.

V-PLMN 120 has a roaming agreement in place with H-PLMN 110 such that when user device 130 roams into coverage of V-PLMN 120, the user device 130 is provided with wireless communication services supported by V-PLMN 120, but subject to policies configured in the H-PLMN 110. V-PLMN 120 includes a visiting network PCF (V-PCF) 122, a visiting network SMF (V-SMF) 124 and a visiting network UPF-SFC (V-UPF-SFC) 126. The V-UPF-SFC 126 directs user plane traffic associated with the user device 130, over N6-LAN 127, to an SFC based on one of a plurality of SFPs that includes, as an example, SFP-A, SFP-B and SFP-C, shown at reference numerals 128-1, 128-2 and 128-3, respectively. The V-PLMN 120 further includes an Access and Mobility Management Function (AMF) 129 that may be configured to play a role in the SFC mapping techniques presented herein.

The H-UPF-SFC 116 of the H-PLMN 110 handles user plane traffic to a user device, e.g., user device 130, from the Internet 140, and from the user device 130 to the Internet 140, as shown at 150. Likewise, the V-UPF-SFC 126 of the V-PLMN 120 handles user plane traffic to the user device 130 from the Internet 140, and from the Internet 140 to the user device 130, for local breakout (LBO), as shown at 160, when user device 130 roams to coverage of the V-PLMN 120.

While not shown in FIG. 1, it is to be understood that there are one or more base stations associated with the H-PLMN 110 and one or more base stations associated with the V-PLMN 120. These base stations transmit signals to, and receive signals from, the one or more user devices, e.g., user device 130. Moreover, the functions shown in the H-PLMN 110, such as the H-PCF 112, H-SMF 114, H-UPF-SFC 116, SFPs 118-1 to 118-3, and UDR 119 need not all be co-located on the same data center or computing location; they may be located in the cloud at one or more different locations. The same applies to the functions shown in the V-PLMN 120.

FIG. 1 further shows a SFC mapping 170 that the V-PCF 122 makes to ensure that the LBO user plane traffic for user device 130 is given the same SFC treatment in V-PLMN 120 as in H-PLMN 110.

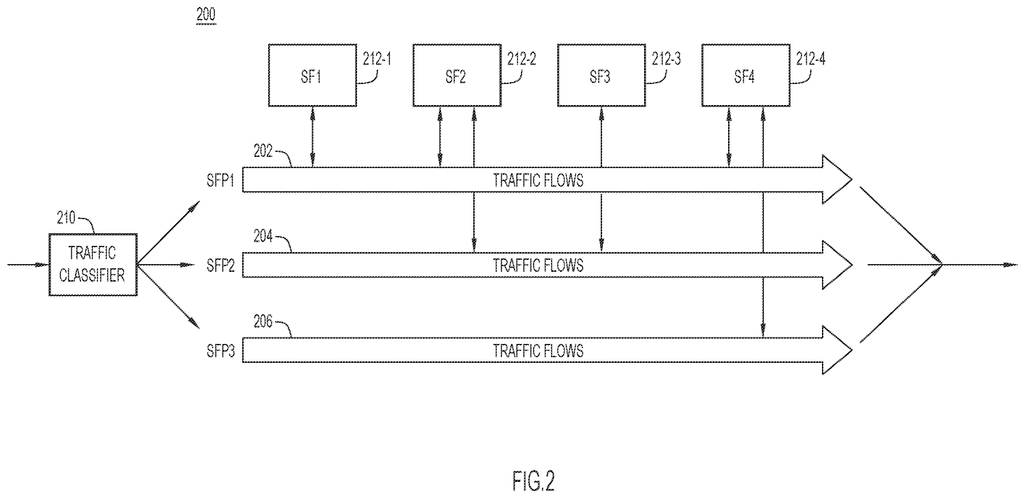

Reference is now made to FIG. 2, with continued reference to FIG. 1. FIG. 2 depicts a diagram 200 that illustrates the overall concept of service function chaining, as described in 3GPP Technical Specification (TS) 23.700-18, that may be employed by a UPF, such as H-UPF-SFC 116 in the H-PLMN 110 or V-UPF-SFC 126 in V-PLMN 120, shown in FIG. 1. In the example shown in FIG. 2, there are three SFPs, SFP1, SFP2 and SFP3, shown at 202, 204 and 206, respectively. A traffic classifier 210 selects which of the SFPs to direct network traffic. Each of the SFPs 202, 204 and 206 uses one of more of a plurality of service functions (SFs). In the example of FIG. 2, there are four SFs: SF1, SF2, SF3 and SF4, shown at reference numerals 212-1, 212-2, 212-3 and 212-4, respectively. SFP1 202 uses SF1, then SF2, then SF4. SFP2 204 uses SF2 followed by SF3. SFP3 206 uses SF4.

Selection of a SFC in the V-PLMN 120 can be a challenge. For a seamless user experience in the roaming network, network operators want to choose the appropriate SFC. This can be driven by the network operator to meet various business requirements with third parties based on service level agreements and availability of the appropriate SFC.

The SFC policy to select the SFP is defined in the UDR 119 in the H-PLMN 110. Network operators configure these policies in the H-PLMN 110 at the time of onboarding a user device. There are no such policies configured for a visited network, e.g., V-PLMN 120, with whom the home operator has a roaming agreement. For example, a given user plane policy may be known and configured for the H-PLMN 110 but the same policy may not be understood in the V-PLMN 120. Service functions in the H-PLMN 110 may not be the same as the SFs in the V-PLMN. As a result, there is a need to do a mapping from the SFCs in the H-PLMN 110 to the SFCs in the V-PLMN 120 to be sure the user traffic for a user device that has roamed to the V-PLMN gets processed appropriately. This is the aforementioned SFC mapping 170 shown in FIG. 1. For example, in the H-PLMN 110, an SFC by a given name can have a Network Address Translation (NAT) service function followed by a video optimizer service function. The same SFC name in the V-PLMN 120 may not have those same two service functions in that order, as desired. In another example, if the SFC in the H-PLMN 110 is NAT followed by a firewall (FW), then it should also be NAT followed by FW in the V-PLMN 120 so that the traffic for the user device is processed the same manner in the user plane in both the H-PLMN 110 and the V-PLMN 120 to give the same user experience.

The techniques presented herein extend the concept of service function chaining to the visited network where a user can enjoy the benefits of SFCs in the roaming network, subject to the roaming agreement.

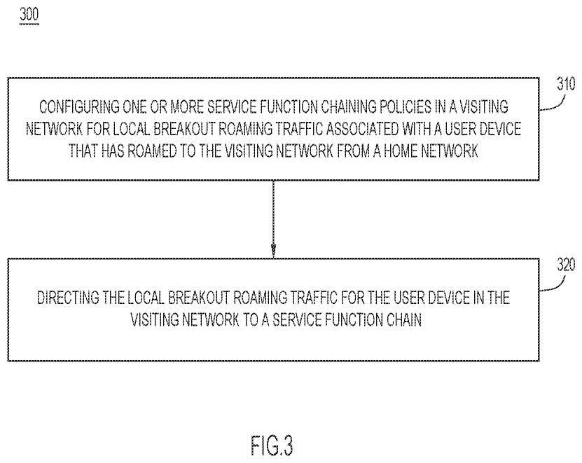

FIG. 3 is a high-level flow chart depicting a method 300 according to an example embodiment. At step 310, the method 300 includes configuring one or more service function chaining policies in a visiting network for local breakout roaming traffic associated with a user device that has roamed to the visiting network from a home network. This configuring involves mapping one or more service function chaining policies of the home network to the one or more service function chaining policies of the visiting network. At 320, the method 300 includes directing the local breakout roaming traffic for the user device in the visiting network to a service function chain determined based on the mapping.

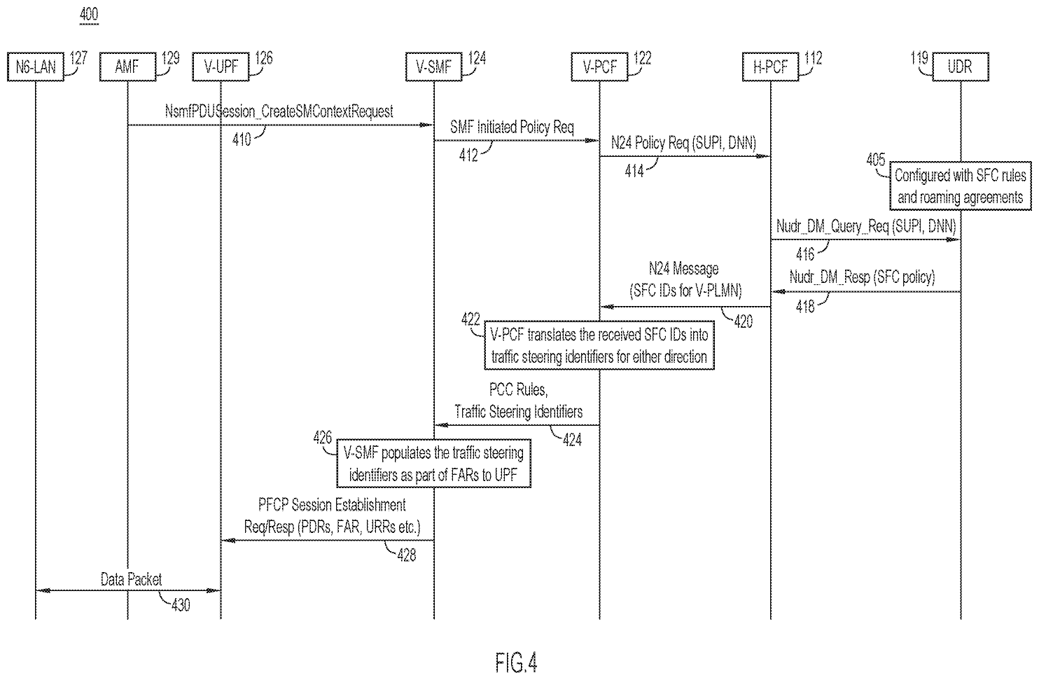

Turning now to FIG. 4, a more detailed sequence diagram for a process 400 is now described to explain in more detail the enhancements and flows presented herein to support the traffic steering with SFC policy in the V-PLMN in the case of LBO roaming. Reference is also made to FIG. 1 for purposes of the description of FIG. 4. The detailed call flow for HR roaming is in TS 23.502. FIG. 4 and the description provided below highlight the changes and message flows to explain these enhancements. The process 400 involves interactions among the AMF 129 in the V-PLMN 120, V-UPF-SFC 126, V-SMF 124, V-PCF 122, H-PCF 112 and UDR 119. In addition, the V-UPF-SFC 126 is shown in communication with the N6-LAN 127 where the various SFCs in the V-PLMN 120 are connected to handle user plane traffic on behalf of an LBO roamed user device.

At 405, the UDR 119 in the H-PLMN is configured with all the SFC rules for the V-PLMN 120 that supports an SFC policy and has roaming agreements in place with the H-PLMN 110.

At 410, the AMF 129 in the V-PLMN 120 sends to the V-SMF 124 a create context request for a packet data unit session on behalf of a user device that roamed to the V-PLMN 120. This is request may be referred to as an NsmfPDUSession_CreateSMContextRequest. In response to receiving the create context request at 410, at 412, the V-SMF 124 sends an SMF initiated policy request (SMF Initiated Policy Req) to the V-PCF 122. At 414, the V-PCF 122 sends a policy request via the N24 interface to the H-PCF 112 in the H-PLMN 110. The policy request sent at 414 may include context information such as the globally unique Subscription Permanent Identifier (SUPI) that is allocated to each subscriber/UE as defined in TS 23.501, along with the Data Network Name (DNN) that indicates the data network to which a PDU session provides connectivity, similar to an Access Point Name in a 4G network.

At 416, the H-PCF 112 sends a query request to the UDR 119 using the SUPI and DNN obtained from the policy request received at 414 from the V-PCF 122. The request that the H-PCF sends at 416 may be referred to as an Nudr_DM_Query_Req (SUPI, DNN). At 418, in response to the query request from the H-PCF 112, the UDR 119 provides the SFC policy rules to the H-PCF 112. The response that the UDR 119 sends at 418 may be referred to as an Nudr_DM_Resp (SFC policy).

At 420, the H-PCF 112 transparently sends the SFC policy rules to the V-PCF 122. Thus, there is a set of SFC rules per PLMN, be it the H-PLMN or the V-PLMN. The H-PCF 112 can check the SFC policy identifiers (IDs) and metadata corresponding to the SFC policy. The metadata can contain information specific to the SFs (service functions) and the H-PCF would transparently pass this information to the V-PCF 122 in a message over the N24 interface, where the message contains the SFC IDs for the V-PLMN. The H-PCF 112 provides the SFC policy (for either direction—uplink user plane traffic and/or downlink user plane traffic) to the V-PCF 122, at 420.

The V-PCF 122 can then determine a policy per service data flow (SDF)/application for the purpose of steering the subscriber's traffic to the appropriate N6-LAN service function chains deployed in V-PLMN 110. Thus, at 422, the V-PCF 122 in the V-PLMN translates from the H-PLMN service function chain configurations or policies to the V-PLMN service function chain configurations or policies based on traffic provisioning and conditions in the V-PLMN. In so doing, the V-PCF 122 performs a mapping of service function chain identifiers to traffic steering identifiers (TSP IDs) configured in the V-PLMN 120.

As an example, set forth below is a mapping table that the V-PCF 122 uses to translate between H-PLMN service function chain configurations or policies to V-PLMN service function chain configurations or policies.

| H-PLMN SFC | V-PLMN SFC |
|---|---|
| SFC-1 FW + NAT | SFC-100 FW + NAT |
| SFC-2 TCP-Opt + FW | SFC-101 TCP-Opt + FW |
| SFC-3 NAT | SFC-102 NAT |
| SFC-4 VOpt + NAT | SFC-103 VOpt + NAT |

NAT—Network address translation function
FW—firewall function
TCP-Opt—Transmission Control Protocol (TCP) optimizer
VOpt—Video optimizer

The mapping table, such as the one shown above, is dynamic insofar as entries can be added, deleted or updated by network/system operators.

At 424, the V-PCF 122 provides the TSP IDs and the metadata (if available) in the Policy and Charging Control (PCC) rules to the V-SMF 124 in the V-PLMN. At 426, the V-SMF 124 then provisions corresponding Packet Detection Rules (PDRs), Forwarding Action Rules (FARs), Quality of Service (QOS) Enforcement Rules (QERs) to support the SFC in the V-PLMN 120. The V-SMF 124 creates a FAR with the Forwarding Policy parameters set to the TSP ID, and the FAR includes the metadata (if available). At 428, the V-SMF 124 provides the PDRs, FARs, etc., to the V-UPF-SFC 126 as part of a Packet Forwarding Control Protocol (PFCP) Session Establishment Request/Response exchange.

At 430, the V-UPF-SFC 126 uses the TSP IDs to steer traffic over the N6-LAN 127 to the appropriate service functions in the V-PLMN 120. The V-UPF-SFC 126 performs the necessary actions to enforce the Forwarding Policy, e.g., performing packet encapsulation, packet marking and routing the traffic towards the service functions in the N6-LAN 127. The V-UPF-SFC 126 provides the metadata (if available) together with the traffic sent to the N6-LAN service functions.

Variations to the sequence flow of FIG. 4 are envisioned. If a new SFC is deployed and available in the V-PLMN (and not available and subscribed in H-PLMN), then the new SFC in the V-PLMAN can be made available based on the roaming agreement and subscription profile (e.g., only for certain subscription levels, such as a higher-level subscription (“Gold” Subscriber)). For example, the TCP Optimizer may only be available in the V-PLMN and not in H-PLMN, but the TCP Optimizer can be provided to a “Gold” subscriber.

If no mapping is found to an SFC in the V-PLMN, then it envisioned that a default SFC may be configured and selected (e.g., SFC-x-NAT).

In summary, a mechanism is provided for traffic classification based on SFC rules in the V-PLMN in case of local breakout roaming scenarios. The SFC rules provisions in the H-PLMN needs to be provided to V-PCF/V-SMF in the V-PLMN which would use the local configuration and traffic condition to map it to SFP (service function path) or SFC.

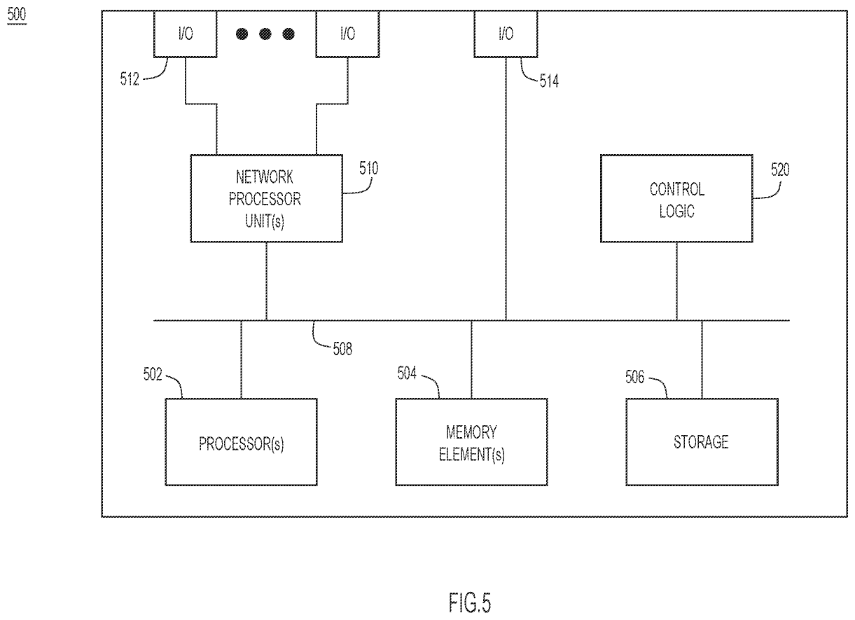

FIG. 5 above illustrates a hardware block diagram of a computing device 500 that may perform functions associated with operations discussed herein in connection with the techniques depicted in the other figures. In various embodiments, a computing device or apparatus, such as computing device 500 or any combination of computing devices 500, may be configured as any entity/entities as discussed for the techniques discussed herein.

In at least one embodiment, the computing device 500 may be any apparatus that may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: configuring one or more service function chaining policies in a visiting network for local breakout roaming traffic associated with a user device that has roamed to the visiting network from a home network, by mapping one or more service function chaining policies of the home network to the one or more service function chaining policies of the visiting network; and directing the local breakout roaming traffic for the user device in the visiting network to a service function chain determined based on the mapping.

In some aspects, the techniques described herein relate to a method, wherein configuring includes: a visiting network policy control function obtaining from a home network policy control function the one or more service function chaining policies of the home network.

In some aspects, the techniques described herein relate to a method, wherein mapping includes the visiting network policy control function determining an appropriate service function chain in the visiting network based on a service data flow/application associated with traffic for the user device.

In some aspects, the techniques described herein relate to a method, wherein determining includes translating from one or more service function chaining policies of the home network to one or more service function chaining policies of the visiting network to identify the appropriate service function chain in the visiting network based on traffic provisioning and conditions in the visiting network.

In some aspects, the techniques described herein relate to a method, wherein the visiting network policy control function further performing mapping of service function chain identifiers to traffic steering identifiers configured in the visiting network.

In some aspects, the techniques described herein relate to a method, further including: the visiting network policy control function providing the traffic steering identifiers to a visiting network session management function; and the visiting network session management function creating a forwarding action rule with a forwarding policy parameters set for the traffic steering identifiers.

In some aspects, the techniques described herein relate to a method, further including: the visiting network session management function configuring a visiting network user plane function based on the forwarding action rule; and the visiting network user plane function using the traffic steering identifiers to steer the traffic for the user device to the user device to one or more service functions in the appropriate service function chain.

In some aspects, the techniques described herein relate to a method, wherein the visiting network user plane function further performs actions to enforce the forwarding policy parameters set including performing packet encapsulation, packet marking and routing of the traffic towards the one or more service functions.

In some aspects, the techniques described herein relate to a method, wherein configuring includes: determining if a new service function chain is deployed and available in the visiting network and not available in the home network; and making the new service function chain in the visiting network available based on a roaming agreement and subscription profile for the user device.

In some aspects, the techniques described herein relate to a method, wherein if no mapping is found to service function chain in the visiting network, configuring includes configuring a default service function in the visiting network for the user device.

In some aspects, the techniques described herein relate to a method, further including: configuring a data management entity in the home network with service function chaining rules for the visiting network that has a roaming agreement in place with the home network for the user device.

In some aspects, the techniques described herein relate to an apparatus including: a memory; one or more network interfaces configured to enable network communication; and one or more processors coupled to the one or more network interfaces and to the memory, wherein the one or more processors are configured to perform operations including: configuring one or more service function chaining policies in a visiting network for local breakout roaming traffic associated with a user device that has roamed to the visiting network from a home network, by mapping one or more service function chaining policies of the home network to the one or more service function chaining policies of the visiting network; and directing the local breakout roaming traffic for the user device in the visiting network to a service function chain determined based on the mapping.

In some aspects, the techniques described herein relate to an apparatus, wherein mapping includes determining an appropriate service function chain in the visiting network based on a service data flow/application associated with traffic for the user device.

In some aspects, the techniques described herein relate to an apparatus, wherein determining includes translating from one or more service function chaining policies of the home network to one or more service function chaining policies of the visiting network to identify the appropriate service function chain in the visiting network based on traffic provisioning and conditions in the visiting network.

In some aspects, the techniques described herein relate to an apparatus, wherein translating further includes mapping of service function chain identifiers to traffic steering identifiers configured in the visiting network.

In some aspects, the techniques described herein relate to one or more non-transitory computer readable storage media encoded with instructions that, when executed by one or more computer processors, cause the one or more computer processors to perform operations including: configuring one or more service function chaining policies in a visiting network for local breakout roaming traffic associated with a user device that has roamed to the visiting network from a home network, by mapping one or more service function chaining policies of the home network to the one or more service function chaining policies of the visiting network; and directing the local breakout roaming traffic for the user device in the visiting network to a service function chain determined based on the mapping.

In some aspects, the techniques described herein relate to one or more non-transitory computer readable storage media, wherein mapping includes determining an appropriate service function chain in the visiting network based on a service data flow/application associated with traffic for the user device.

In some aspects, the techniques described herein relate to one or more non-transitory computer readable storage media, wherein determining includes translating from one or more service function chaining policies of the home network to one or more service function chaining policies of the visiting network to identify the appropriate service function chain in the visiting network based on traffic provisioning and conditions in the visiting network.

In some aspects, the techniques described herein relate to one or more non-transitory computer readable storage media, wherein translating further includes mapping of service function chain identifiers to traffic steering identifiers configured in the visiting network.

In some aspects, the techniques described herein relate to one or more non-transitory computer readable storage media, wherein configuring includes: determining if a new service function chain is deployed and available in the visiting network and not available in the home network; and making the new service function chain in the visiting network available based on a roaming agreement and subscription profile for the user device.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
configuring one or more service function chaining policies in a visiting network for local breakout roaming traffic associated with a user device that has roamed to the visiting network from a home network, by mapping one or more service function chaining policies of the home network to the one or more service function chaining policies of the visiting network; and
directing the local breakout roaming traffic for the user device in the visiting network to a service function chain determined based on the mapping.

2. The method of claim 1, wherein configuring includes:
a visiting network policy control function obtaining from a home network policy control function the one or more service function chaining policies of the home network.

3. The method of claim 2, wherein mapping includes the visiting network policy control function determining an appropriate service function chain in the visiting network based on a service data flow/application associated with traffic for the user device.

4. The method of claim 3, wherein determining includes translating from one or more service function chaining policies of the home network to one or more service function chaining policies of the visiting network to identify the appropriate service function chain in the visiting network based on traffic provisioning and conditions in the visiting network.

5. The method of claim 4, wherein the visiting network policy control function further performing mapping of service function chain identifiers to traffic steering identifiers configured in the visiting network.

6. The method of claim 5, further comprising:
the visiting network policy control function providing the traffic steering identifiers to a visiting network session management function; and
the visiting network session management function creating a forwarding action rule with a forwarding policy parameters set for the traffic steering identifiers.

7. The method of claim 6, further comprising:
the visiting network session management function configuring a visiting network user plane function based on the forwarding action rule; and
the visiting network user plane function using the traffic steering identifiers to steer the traffic for the user device to the user device to one or more service functions in the appropriate service function chain.

8. The method of claim 7, wherein the visiting network user plane function further performs actions to enforce the forwarding policy parameters set including performing packet encapsulation, packet marking and routing of the traffic towards the one or more service functions.

9. The method of claim 1, wherein configuring comprises:
determining if a new service function chain is deployed and available in the visiting network and not available in the home network; and
making the new service function chain in the visiting network available based on a roaming agreement and subscription profile for the user device.

10. The method of claim 1, wherein if no mapping is found to service function chain in the visiting network, configuring comprises configuring a default service function in the visiting network for the user device.

11. The method of claim 1, further comprising:
configuring a data management entity in the home network with service function chaining rules for the visiting network that has a roaming agreement in place with the home network for the user device.

12. An apparatus comprising:
a memory;
one or more network interfaces configured to enable network communication; and
one or more processors coupled to the one or more network interfaces and to the memory, wherein the one or more processors are configured to perform operations including:
configuring one or more service function chaining policies in a visiting network for local breakout roaming traffic associated with a user device that has roamed to the visiting network from a home network, by mapping one or more service function chaining policies of the home network to the one or more service function chaining policies of the visiting network; and
directing the local breakout roaming traffic for the user device in the visiting network to a service function chain determined based on the mapping.

13. The apparatus of claim 12, wherein mapping includes determining an appropriate service function chain in the visiting network based on a service data flow/application associated with traffic for the user device.

14. The apparatus of claim 13, wherein determining includes translating from one or more service function chaining policies of the home network to one or more service function chaining policies of the visiting network to identify the appropriate service function chain in the visiting network based on traffic provisioning and conditions in the visiting network.

15. The apparatus of claim 14, wherein translating further includes mapping of service function chain identifiers to traffic steering identifiers configured in the visiting network.

16. One or more non-transitory computer readable storage media encoded with instructions that, when executed by one or more computer processors, cause the one or more computer processors to perform operations including:
configuring one or more service function chaining policies in a visiting network for local breakout roaming traffic associated with a user device that has roamed to the visiting network from a home network, by mapping one or more service function chaining policies of the home network to the one or more service function chaining policies of the visiting network; and
directing the local breakout roaming traffic for the user device in the visiting network to a service function chain determined based on the mapping.

17. The one or more non-transitory computer readable storage media of claim 16, wherein mapping includes determining an appropriate service function chain in the visiting network based on a service data flow/application associated with traffic for the user device.

18. The one or more non-transitory computer readable storage media of claim 17, wherein determining includes translating from one or more service function chaining policies of the home network to one or more service function chaining policies of the visiting network to identify the appropriate service function chain in the visiting network based on traffic provisioning and conditions in the visiting network.

19. The one or more non-transitory computer readable storage media of claim 18, wherein translating further includes mapping of service function chain identifiers to traffic steering identifiers configured in the visiting network.

20. The one or more non-transitory computer readable storage media of claim 16, wherein configuring comprises:
determining if a new service function chain is deployed and available in the visiting network and not available in the home network; and
making the new service function chain in the visiting network available based on a roaming agreement and subscription profile for the user device.
